(19) United States
(12) Patent Application Publication
(10) Pub. No.: US 2013/0046678 A1
(43) Pub. Date: Feb. 21, 2013

(54) MINIMUM PAYMENT REQUIREMENTS FOR A REVOLVING ACCOUNT

(71) Applicants: Erik Stephen Ross, Charlotte, NC (US); Lewis Ray Ware, Hockessin, DE (US)

(72) Inventors: Erik Stephen Ross, Charlotte, NC (US); Lewis Ray Ware, Hockessin, DE (US)

(73) Assignee: BANK OF AMERICA CORPORATION, Charlotte, NC (US)

(21) Appl. No.: 13/213,758

(22) Filed: Aug. 19, 2011

(51) Int. Cl. G06Q 40/00

(52) U.S. Cl. 705/38

(57) ABSTRACT

The minimum payment requirement for a customer may be a higher amount than conventional or industry-standard credit cards. In one exemplary embodiment, at least one memory storing computer executable instructions that, when executed, cause the apparatus at least to: provide a minimum payment requirement towards a balance associated with a revolving account, wherein the minimum payment requirement is approximately 15-25% of the balance, provide an interest rate for the revolving account that is a function of the minimum payment requirement, and initiate the execution of an assessment if the minimum payment requirement is not met.

### TECHNICAL FIELD

Aspects of the disclosure relate to apparatus and methods associated with revolving accounts. More specifically, aspects of the disclosure relate to an increased minimum payment requirement for an outstanding balance in exchange for reduced interest rates.

### BACKGROUND

A credit card issuer, such as a bank or credit union, may approve an account for a customer and issue a revolving account to the customer. Specifically, the issuer may approve an account for a customer and issue a credit card to the customer. Customers may make purchases at retailers or other merchants accepting that card. When a purchase is made, the customer agrees to pay the card issuer for the amount charged. Merchants may use electronic verification systems to confirm that the card is valid and that the customer has sufficient credit. Each month, the issuer may send the customer a statement listing the purchases made with the card, and the amount owed. The customer may pay a minimum amount up to the entire balance by a due date. Interest may be assessed on the amount owed if not paid in full based on an Annual Percentage Rate (APR) or other types of interest rates.

The credit card issuer often requires a minimum payment amount or rate on an outstanding balance. The industry standard may generally be to calculate the minimum payment in one of two ways: either three percent to five percent of the total balance of the credit card, or all fees and interest due that month, plus one percent of the principal amount owed. If the minimum payment amount is not made, the credit card issuer may charge a penalty or minimum account payment fee and place the account into default. Additionally, the APR is generally based on the credit card issuer's risk evaluation and the borrower's credit history.

### BRIEF SUMMARY

The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

In accordance with aspects of the disclosure, an apparatus with at least one processor; and at least one memory storing computer executable instructions is disclosed. The executable instruction, when executed, cause the apparatus at least to: provide a minimum payment requirement towards a balance associated with a revolving account, wherein the minimum payment requirement is approximately 15-25% of the balance, provide an interest rate for the revolving account that is a function of the minimum payment requirement, and initiate the execution of a penalty if the minimum payment requirement is not met. The revolving account may be a credit card account as an example. Other examples could be mortgages, car loans, etc.

In another embodiment in accordance with aspects of the disclosure, a method for executing a transaction for a revolving account having an adjusted interest rate in exchange for a higher minimum payment requirement is disclosed. The method may include: providing, by a processor, a minimum payment requirement towards a balance associated with the revolving account; providing, by a processor, an interest rate in combination with the minimum payment requirement; and initiating, by a processor, execution of a penalty if the minimum payment requirement is not met, wherein the penalty includes one or more of the following: stopping all future transactions on the balance, automatically reducing the credit limit or maximum balance until the minimum payment requirement is met, or imposing a fee. The revolving account may be a credit card account as an example. Other examples could be mortgages, car loans, etc.

In another embodiment in accordance with aspects of the disclosure, a method for executing a transaction for a revolving account having an adjusted interest rate based on a spending behavior of a customer is disclosed. The method may include: providing, by a processor, a minimum payment requirement towards a balance associated with a revolving account; authorizing, by a processor, a transaction for a purchase associated with the revolving account; categorizing, by a processor, the transaction into a transaction category; and increasing the minimum payment requirement when one or more of the transaction categories include one of a plurality of predetermined discretionary purchase categories. The revolving account may be a credit card account as an example. Other examples could be mortgages, car loans, etc.

One skilled in the art will appreciate that one or more of the aforementioned systems, methods, and features may be embodied as computer-executable instructions stored on a computer-readable medium and/or memory, where execution of the computer-executable instructions by a processor causes a computer or other apparatus to perform the operations described herein.

### BRIEF DESCRIPTION OF THE DRAWINGS

The present disclosure is illustrated by way of example and not limited in the accompanying figures in which like reference numerals indicate similar elements and in which:

FIG. 1 shows an illustrative operating environment in which various aspects of the disclosures may be implemented in accordance with example embodiments.

FIG. 2 is an illustrative block diagram of workstations and servers that may be used to implement the processes and functions of certain aspects of the present disclosure in accordance with example embodiments.

FIG. 3 illustrates an example flow diagram of a method for executing a transaction for an account having an adjusted interest rate in exchange for a higher minimum monthly payment in accordance with example embodiments.

FIG. 4 illustrates an example flow diagram of another method for executing a transaction for an account having an adjusted interest rate based on the spending behavior of a customer in accordance with example embodiments.

FIG. 5 illustrates an example flow diagram of another method for executing a transaction for an account in accordance with example embodiments.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure.

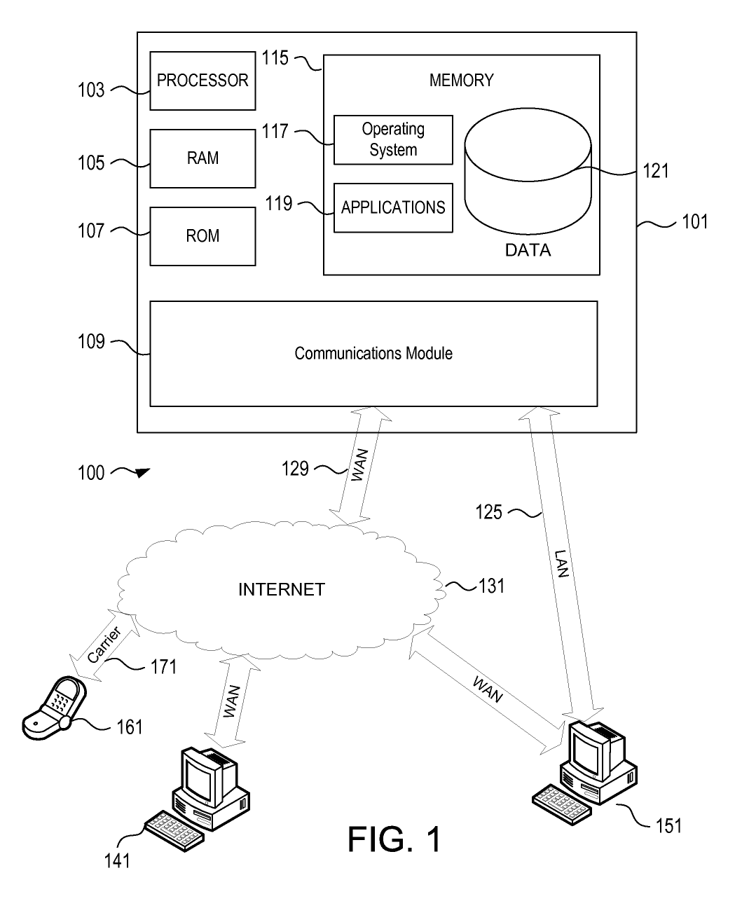

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 825 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 101. Such a processor may execute computer-executable instructions stored on a computer-readable medium.

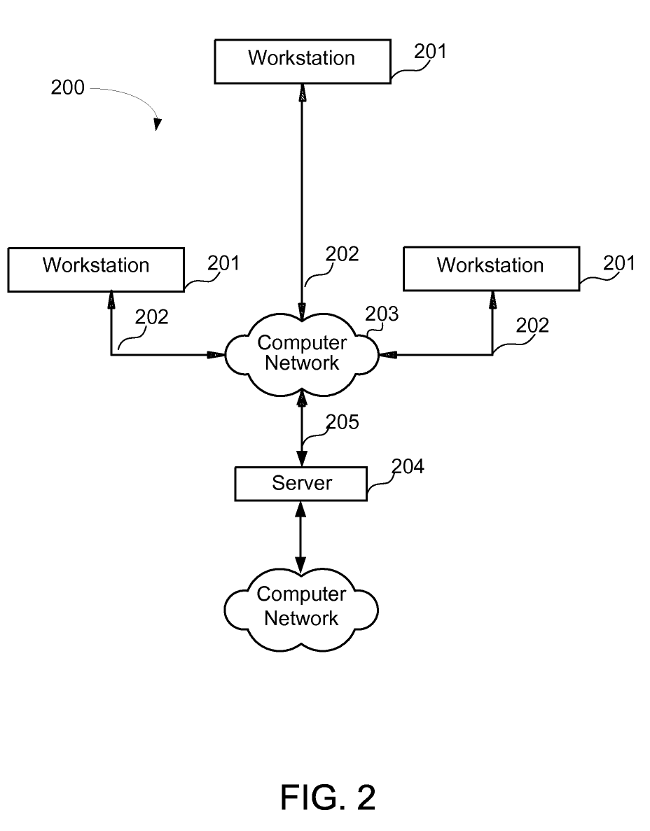

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

In an example and with reference to FIG. 1, a computing device 101, which includes a processor 103, may be associated with a financial institution, such as a bank or other entity. One or more customers may have a financial account or revolving account (e.g., credit card account, mortgage, car loan, brokerage, etc.) or other financial product and/or service with the financial institution. To incentivize the customer to continue using the financial account, the financial institution may offer incentives to the customer.

The embodiments are directed towards a revolving account. The revolving account may be a credit card account as an example. Other examples could be mortgages, car loans, etc. For example, when a customer pays with a credit card at a retailer, the computer of the retailer may communicate with the processor 103 to authorize the transaction amount. Following this authorization, the transaction amount may then be added to the credit card balance. The customer may be required to pay a minimum amount towards the credit card balance, which may be referred to as a minimum payment or minimum payment requirement. Conventional industry standards for the calculation of the minimum payment requirement for a customer or user may be in one of two ways: 1) a low fixed percentage of the total balance of the credit card, typically three percent to five percent of the total balance of the credit card, or 2) all fees and interest due that month, plus one percent of the principal amount owed. Both of these methods lead to a slow repayment plan towards the credit card balance and are not helpful to the customer or the bank, as many times these minimum payments lead to accounts in default.

In an example aspect, the minimum payment requirement for a customer may be a higher amount than conventional or industry-standard credit cards. In one exemplary embodiment, the minimum payment requirement may be 15% of the outstanding balance of the credit card. In another exemplary embodiment, the minimum payment requirement may be 25% of the outstanding balance of the credit card. In another exemplary embodiment, the minimum payment requirement may be 35% of the outstanding balance of the credit card. The minimum payment requirement may also be other percentages of the outstanding balance.

In exchange for a customer having a higher minimum payment requirement, the financial institution may offer a lower interest rate or APR associated with the credit card. This interest rate may be low enough to be financially attractive to those customers who have a revolving outstanding balance from time to time or carry a modest and stable outstanding balance.

In an example aspect of this invention, the higher minimum payment requirement with a lower interest rate revolving account or credit card account may be offered or targeted to affluent customers. These affluent customers may normally pay cash for purchases and never have a revolving account, or may only have a revolving account for some limited amounts of the time. By offering the higher minimum payment requirement credit card with a lower interest rate, the affluent customers may be influenced to use a credit card with a higher minimum payment requirement and lower interest rate. For example, an affluent customer may be able to pay off a credit card purchase in a three or six month period with little interest rate.

For example, a customer may be offered a traditional minimum payment plan that includes the traditional minimum payment requirement of approximately 5% with an APR of 15%. In addition, for some customers as identified by the financial institution, a customer may be offered a credit card in accordance with example embodiments. This credit card may include a minimum payment requirement of approximately 15% of the outstanding balance, however the APR may be less, such as 12.5%. Therefore, while the minimum payment requirement of 15% is higher than the traditional minimum payment requirement of 5%, the customer has a lower APR interest rate of 12.5% as compared to 15% with the traditional plan. Additionally, the financial institution may offer another minimum payment requirement for a credit card that may include a minimum payment requirement of approximately 25% of the outstanding balance with an APR of 10%. Those of skill in the art will understand that these percentages are merely examples and that the concept of a higher minimum payment requirement percentage coupled with a lower APR could include an infinite amount of different percentages. The financial institutions, along with the customer demand, will set these percentages in the marketplace.

With the increased amount for the minimum payment requirement, the potential and/or possibility of the minimum payment requirement not being met with the correct amount or on time may increase. Therefore, in another exemplary embodiment, the credit card issuer may charge or impose a penalty if the minimum payment requirement is not met.

The penalty may include many different actions by the financial institution. One potential penalty may include the financial institution and/or processor 103 stopping authorization of all future transactions or shutting-off charging privileges until the minimum payment requirement is met. Additionally, the penalty may include the processor 103 automatically reducing the credit line of the credit card until the minimum payment requirement is met. The penalty may also include the processor 103 automatically reducing the credit line of the credit card permanently. The penalty may also include the processor 103 imposing a fee or fine on the customer for not meeting the minimum payment requirement. In another scenario, the penalty may include removal of the customer from the high minimum payment requirement plan. Without departing from the example embodiments, any of the above penalties may be imposed alone or in combination by the financial institution when the minimum payment requirement is not met.

In further aspects of the example embodiments, the minimum payment requirement may be based on the spending behavior of a customer. Purchases may be defined as discretionary purchases or non-discretionary purchases. Generally, discretionary purchases may be defined as those purchases that are necessary, such as for food, shelter, and/or clothing. In contrast, non-discretionary purchases may be defined as those purchases that are for items above and beyond those that are necessary, i.e. luxury items. Additionally, a certain total amount of purchases in a category (e.g., clothing) per time interval (e.g., per month) may be non-discretionary, but any purchases beyond those amounts/limits may be considered discretionary purchases. In this embodiment, the financial institution and/or processor 103 may institute a set of multi-tiered payment rules based on a set of categories of the transactions, wherein the minimum payment requirement goes up if the customer makes a lot of discretionary purchases.

In this exemplary embodiment, the customer may pay with a credit card at a retailer, and a computer of the retailer may communicate with the processor 103 to authorize the transaction. As the transaction is authorized, the transaction may be assigned a transaction category. Based on this transaction category, the processor 103 may then automatically categorize the transaction as a discretionary purchase. Generally, discretionary purchases may be identified as electronics, travel, and/or other luxury items. Additionally, the processor 103 may automatically categorize a transaction based on the amount being over a certain amount.

In another example embodiment, the processor 103 may assign a Merchant Category Code (MCC) to assist with the transaction category. In general, MCCs are a classification code that is assigned by a financial institution to a merchant/payee. The credit card organization/financial institution may assign the merchant a particular code based on the predominant business activity of the merchant. The MCC may be assigned by the processor 103 based on the transaction and the type of goods or services included with the transaction. For example, if the transaction includes computers, the transaction may be assigned MCC 5732 “Computer Hardware”. If the transaction is for the repair of computers, the transaction may be assigned MCC 7379 “Computer Maintenance, Repair, and Services”. A list of MCCs may be found on the website of the Internal Revenue Service. Other classification codes may be used.

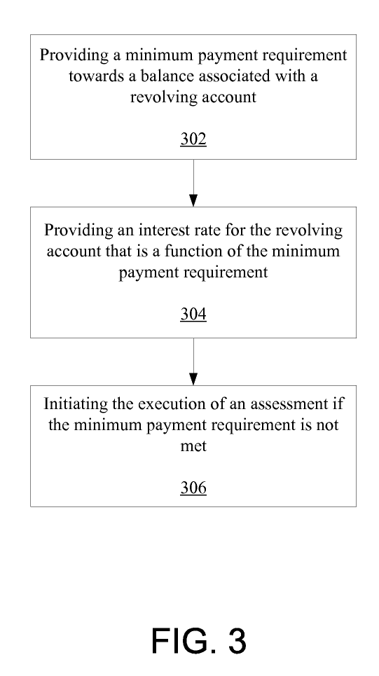

FIG. 3 illustrates an example flow diagram of a method for executing a transaction for a revolving account having an adjusted interest rate in exchange for a higher minimum monthly payment in accordance with an example embodiment. The revolving account may be a credit card account as an example. Other examples could be mortgages, car loans, etc. The method may be implemented by the processor 103 or other computer. The order of the blocks depicted in FIG. 3 may be rearranged, one or more blocks may be repeated in sequential and/or non-sequential order, and/or one or more blocks may be omitted. Further, other blocks may be added to the flow diagram. The method may begin at block 302.

In block 302, the method may include providing a minimum payment requirement towards a balance associated with a revolving account. The minimum payment requirement may be 15% of the outstanding balance. In another embodiment, the minimum payment requirement may be 25% or even 35% of the outstanding balance.

In block 304, the method may further include providing an interest rate for the revolving account that is a function of the minimum payment requirement. For example, when the minimum payment requirement towards the balance associated with the revolving account is a higher percentage of the outstanding balance of the revolving account, the interest rate for the revolving account may be lower. Similarly, when the minimum payment requirement towards the balance associated with the revolving account is a lower percentage of the outstanding balance of the revolving account, the interest rate for the revolving account may be higher. This functional relationship may be set by the financial institution. The interest rate may be an APR. This interest rate may be lower than traditional or conventional interest rates to offset the high minimum payment requirement percentage.

Additionally, the method may include providing multiple minimum payment requirements in combination with multiple interest rates, wherein the user may be allowed to select from one of the minimum payment requirement and interest rate combinations. For example, the method may include providing a minimum payment requirement of X1 and an interest rate of R1, wherein X1 represents a minimum payment requirement equivalent to a conventional or traditional minimum payment requirement and R1 represents an interest rate equivalent to a conventional or traditional interest rate. Additionally, the method may include providing a minimum payment requirement of X2 and an interest rate of R2, wherein X2 represents a minimum payment requirement greater than X1 and R2 represents an interest rate less than R1. Additionally, the method may include providing a minimum payment requirement of X3 and an interest rate of R3, wherein X3 represents a minimum payment requirement greater than X1 and X2, while R3 represents an interest rate less than R1 and R2. Additionally, the method may include providing a minimum payment requirement of X4 and an interest rate of R4, wherein X4 represents a minimum payment requirement greater than X1, X2, and X3, while R4 represents an interest rate less than R1, R2, and R3. A plurality of different combinations of minimum payment requirements and interest rates may be utilized without departing from the example embodiments.

In block 306, the method may include initiating the execution of a penalty if the minimum payment requirement is not met. The initiating of the execution of a penalty may comprise stopping the authorization of all future transactions or shutting-off charging privileges until the minimum payment requirement is met. Additionally, the initiating of the execution of a penalty may comprise automatically reducing the credit line or maximum balance of the revolving account until the minimum payment requirement is met. Additionally, the initiating of the execution of a penalty may comprise imposing a fee on the customer for not meeting the minimum payment requirement.

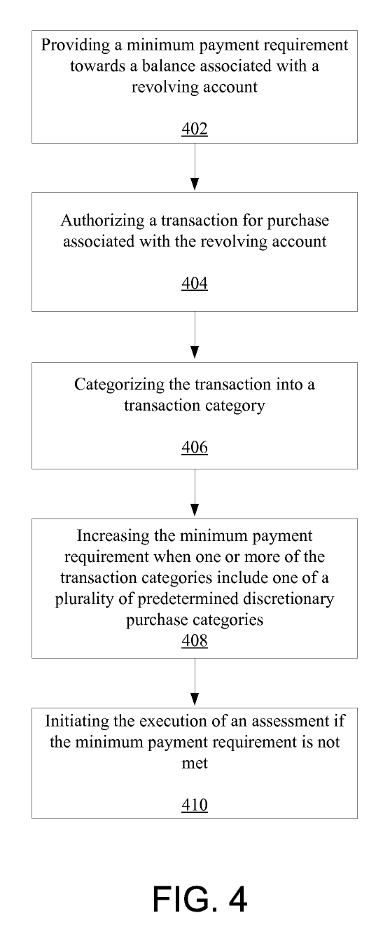

FIG. 4 illustrates an example flow diagram of another method for executing a transaction for an account having an adjusted interest rate based on the spending behavior of a customer in accordance with an example embodiment. The method may be implemented by the processor 103 or other computer. The order of the blocks depicted in FIG. 4 may be rearranged, one or more blocks may be repeated in sequential and/or non-sequential order, and/or one or more blocks may be omitted. Further, other blocks may be added to the flow diagram. The method may begin at block 402.

In block 402, the method may include providing a minimum payment requirement towards a balance associated with a revolving account. The minimum payment requirement may be 15% of the outstanding balance. In another embodiment, the minimum payment requirement may be 25% or even 35% of the outstanding balance.

In block 404, the method may include authorizing a transaction for a purchase associated with the revolving account. For example, with a credit card account, when a customer pays with a credit card at a retailer, a computer of the retailer may communicate with the processor 103 to authorize the transaction.

Following the authorization of the transaction, in block 406, the method may include categorizing the transaction into a transaction category. The categorizing of the transaction into a transaction category may comprise assigning a Merchant Category Code (MCC) based on the transaction and type of goods or services included with the transaction.

In block 408, the method may include increasing the minimum payment requirement when one or more of the transaction categories include one of a plurality of predetermined discretionary purchase categories. The plurality of predetermined discretionary purchase categories may include one or more of the following: electronics, travel, or luxury items.

In block 410, the method may include initiating the execution of a penalty if the minimum payment requirement is not met. The initiating of the execution of a penalty may comprise stopping the authorization of all future transactions or shutting-off charging privileges until the minimum payment requirement is met. Additionally, the initiating of the execution of a penalty may comprise automatically reducing the credit line or maximum balance of the credit card until the minimum payment requirement is met. Additionally, the initiating of the execution of a penalty may comprise imposing a fee on the customer for not meeting the minimum payment requirement.

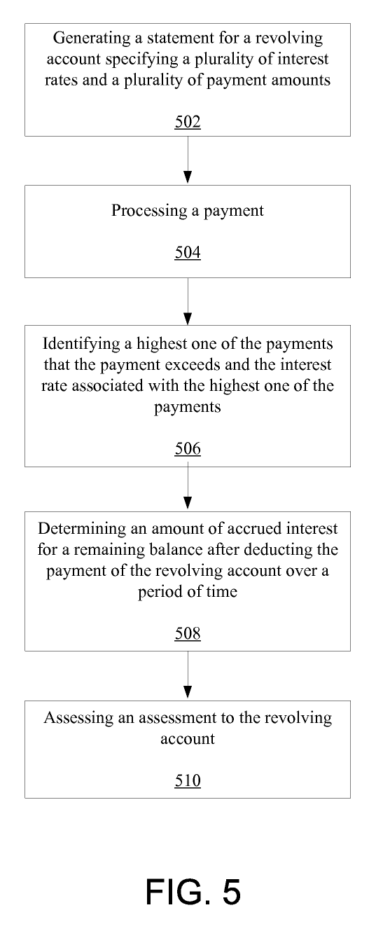

In another example embodiment, FIG. 5 illustrates another example flow diagram of a method for executing a transaction for a revolving account wherein a user may select a payment amount to control the interest rate for a time period. The method may be implemented by the processor 103 or other computer. The order of the blocks or steps depicted in FIG. 5 may be rearranged, one or more blocks or steps may be repeated in sequential and/or non-sequential order, and/or one or more blocks or steps may be omitted. Further, other blocks or steps may be added to the flow diagram. The method may begin at block 502.

In block 502, the method may include generating a statement for a revolving account. The revolving account may be specified or defined by a plurality of interest rates and a plurality of payment amounts. Each of the interest rates may be associated with one of the payment amounts. Each of the interest rates may differ from one another and each of the payment amounts may differ from one another. In the statement, a balance may be associated with the revolving account wherein the balance is the total amount due on the revolving account. As was described above, the revolving account may include examples such as a credit card account, a loan account, or a mortgage account.

In block 504, the method may include processing a payment. The payment may be associated with paying down the balance on the revolving account. The amount of the payment may be selected by the customer. The minimum payment amount may set by the financial institution. The customer may then select a payment above the minimum payment amount.

Following the processing of the payment, and if the payment exceeds at least one of the payment amounts or the minimum payment amount, in block 506, the method further includes identifying a highest one of the payments that the payment exceeds and the interest rate associated with the highest one of the payments. In a block 508, the method further includes determining an amount of accrued interest for the remaining balance of the revolving account. This determination may be based on the interest rate associated with the highest one of the payments. Additionally, the determination may be after deducting the payment from the revolving account over a period of time. The period of time may be for example, monthly or annually. Other periods of time may also be utilized.

In a block 510, the method may include assessing a penalty to the revolving account. For example, if the payment processed and selected by the customer on the revolving account does not exceed any of the payment amounts, a penalty may be assessed to the revolving account. Similarly, if the payment processed and selected by the customer on the revolving account does not exceed minimum payment amount, the penalty may be assessed to the revolving account. The penalties may be any of the penalties as previously described in the above descriptions, such as stopping authorization of all future transactions, automatically reducing the credit limit, and/or imposing a fee.

Aspects of the embodiments have been described in terms of illustrative embodiments thereof Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

1. An apparatus comprising:
at least one processor; and
at least one memory storing computer executable instructions that, when executed, cause the apparatus at least to:
provide a minimum payment requirement towards a balance associated with a revolving account, wherein the minimum payment requirement is approximately 15-25% of the balance,
provide an interest rate for the revolving account that is a function of the minimum payment requirement, and.
initiate the execution of an assessment if the minimum payment requirement is not met.

2. The apparatus of claim 1, wherein the initiating the execution of the assessment comprises stopping authorization of all future transactions using the revolving account.

3. The apparatus of claim 1, wherein the initiating the execution of the assessment comprises automatically reducing a credit limit of the revolving account until the minimum payment requirement is met.

4. The apparatus of claim 1, wherein the initiating the execution of the assessment comprises imposing a fee on the revolving account.

5. The apparatus of claim 1, wherein the interest rate is an annual percentage rate (APR).

6. The apparatus of claim 1, wherein the revolving account is a credit card account.

7. The apparatus of claim 1, wherein the revolving account is a mortgage account.

8. A method comprising:
providing, by a processor, a minimum payment requirement towards a balance associated with a revolving account;
providing, by the processor, an interest rate for the revolving account that is a function of the minimum payment requirement; and
assessing an assessment to the revolving account in response to determining that the minimum payment requirement is not met, wherein the assessment includes one or more of the following: stopping authorization of all future transactions using the revolving account, automatically reducing a credit limit of the revolving account until the minimum payment requirement is met, or imposing a fee on the revolving account.

9. The method of claim 8, wherein the minimum payment requirement is approximately 15% of the outstanding balance associated with the revolving account.

10. The method of claim 8, wherein the minimum payment requirement is approximately 25% of the outstanding balance associated with the revolving account.

11. The method of claim 8, wherein the providing the interest rate comprises: identifying a selection of one of multiple payment amounts as being the minimum payment requirement, wherein each of the payment amounts is associated with a different interest rate.

12. A method comprising:
providing, by a processor, a minimum payment requirement towards a balance associated with a revolving account;
authorizing, by the processor, a transaction using the revolving account;
categorizing, by the processor, the transaction into a particular one of a plurality of transaction categories, the plurality of transaction categories comprising a discretionary purchase category and a non-discretionary purchase category; and
increasing the minimum payment requirement in response to determining that the particular transaction categories is the discretionary purchase category.

13. The method of claim 12, wherein the minimum payment requirement is approximately 15% of the balance associated with the revolving account.

14. The method of claim 12, wherein the minimum payment requirement is approximately 25% of the balance associated with the revolving account.

15. The method of claim 12, wherein the categorizing the transaction into the transaction category includes assigning a merchant category code based on the transaction.

16. The method of claim 12, wherein the plurality of predetermined discretionary purchase categories includes one or more of the following: electronics, travel, or luxury items.

17. The method of claim 12, further including assessing a an assessment to the revolving account in response to the minimum payment requirement not being met.

18. The method of claim 17, wherein the assessment stops the authorization of all future transactions using the revolving account.

19. The method of claim 17, wherein the assessment automatically reduces the credit limit of the revolving account until the minimum payment requirement is met.

20. A method comprising:
generating a statement for a revolving account specifying a plurality of interest rates and a plurality of payment amounts, each of the interest rates being associated with one of the payment amounts, each of the interest rates differing from one another, and each of the payment amounts differing from one another;
processing a payment;
wherein if the payment exceeds at least one of the payment amounts:
identifying a highest one of the payments that the payment exceeds and the interest rate associated with the highest one of the payments, and determining, based on the interest rate associated with the highest one of the payments, an amount of accrued interest for a remaining balance, after deducting the payment, of the revolving account over a period of time; and
wherein if the payment does not exceed any of the payment amounts, assessing an assessment to the revolving account.
